(19) United States
(12) Patent Application Publication
(10) Pub. No.: US 2006/0095628 A1
(43) Pub. Date: May 4, 2006

(54) External-Network Data Content Exposure to Network-Connected Devices

(75) Inventors: Charles Alan Ludwig, Renton, WA (US); James H. Dooley IV, Bellevue, WA (US); Jason S. Flaks, Bellevue, WA (US); Jose Daniel Contreras, Redmond, WA (US); Oren Rosenbloom, Redmond, WA (US); Sean D. Kelly, Redmond, WA (US); Vladimir Sadovsky, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,159

(22) Filed: Dec. 15, 2005

Related U.S. Application Data
(63) Continuation-in-part of application No. 10/742,588, filed on Dec. 19, 2003.

(51) Int. Cl. G06F 13/00

(52) U.S. Cl. 710/302

(57) ABSTRACT

Described herein are one or more implementations for exposing data content (e.g., digital media) of a portable digital media device over a network to one or more network-connected electronics devices, where such exposing is done via a network-connected personal computer to which the portable digital media device is directed coupled (e.g., via a USB). Also, described herein are one or more implementations for gathering a customized collection of data content from web-feeds at a web-connected personal computer and exposing that gathered web-feed data content to a network-connected electronics devices (such as a set-top box for a television).

### CROSS-REFERENCE TO RELATED APPLICATION

The present application claims priority to and is a continuation-in-part to co-pending U.S. patent application Ser. No. 10/742,588, filed on Dec. 19, 2003 and entitled “Routing of Resource Information in a Network,” which is incorporated herein by reference.

### BACKGROUND

This background section will briefly cover background material for three topics of interest in relationship to the implementations described herein. Those topics are Universal Plug and Play (UPnP), PC-coupled (e.g., USB) data-content devices, and web-feeds (e.g., RSS).

Universal Plug and Play (UPnP)

Universal Plug and Play (UPnP) provides a network architecture that facilitates adding and removing devices from a network. For instance, the UPnP architecture allows a user to simply “plug” a new device into a network coupling; thereafter, the network will automatically determine the new device's characteristics and subsequently coordinate interaction between this new device and others in the network based on the determined characteristics. The UPnP architecture is particularly well suited for networks associated with a local setting, such as a home, a business, a school, etc. (Note that the term “Universal Plug and Play” derives from functionality provided in the earlier developed device Plug and Play (PnP); device PnP provides a flexible technique for automatically adding and removing peripherals to a standalone computer device, such as a PC).

An exemplary UPnP architecture and its conventional functions are shown in FIGS. 1 and 2 of co-pending U.S. patent application Ser. No. 10/742,588 (which is incorporated herein by reference) and the textual descriptions associated with those drawings figures. Furthermore, the UPnP Forum's web site (i.e., http://upnp.org/) provides additional and more detailed information regarding the UPnP architecture and related topics.

PC-Coupled Data-Content Devices

With increasing frequency, personal computers (and set-top boxes and other computing devices) have the capability to directly couple with portable, removable storage devices. Such a removable storage device may consist of, for example, a solid-state flash drive, a hard-drive mounted in a chassis, or other device non-volatile memory. These devices may include those whose primary function is to store data and those that have other primary functions (such as playing multimedia stored on the device). An example of the latter is a digital media player or a so-called “mp3-player” or “digital video player.”

These portable and removable devices are typically connected to a personal computer via a “firewire,” a universal serial bus (USB), or similar short-range device coupling physical interface cabling. This makes it easy for a user to store data and multimedia on the removable device and then unplug the device for portability.

Digital media (such as music and video) is often protected via a form of Digital Rights Management (DRM) and it is common for a portable digital media player to respect and help manage the DRM rights of digital media stored thereon. Therefore, a DRM-protected media file stored on an authorized portable media device will play on the device, but will not play if transferred to an unauthorized device or personal computer. Web-Feeds

Recently, web-feeds have grown increasingly more popular. A web-feed is a generic term for web-syndicated data content that is sent to those on the web (i.e., the Internet) who have subscribed for updates to such data content. Web-feeds are presumably most often used on websites (or weblogs) on which the data content is updated often. Examples of such data content includes, for example, news feeds, events listings, weather updates, news stories, headlines, project updates, and excerpts from discussion forums.

Web-feeds are best known by the term “RSS” or “RSS-feeds,” which is the name of the most common format of web-feeds. RSS is a family of XML file-formats for web syndication. The exact meaning of the abbreviation “RSS” depends upon the context, but it always refers to a web-feed protocol standard or format.

According to Wikipedia (http://en.wikipedia.org/), the RSS formats typically provide web content or summaries of web content together with links to the full versions of the content, and other meta-data. This information is delivered as an XML file called an “RSS feed,” “webfeed,” “RSS stream,” or “RSS channel.” In addition to facilitating syndication, RSS allows a website's frequent readers to track updates on the site using an “aggregator.”

According to Wikipedia, “RSS is widely used by the weblog community to share the latest entries' headlines or their full text, and even attached multimedia files. (See podcasting, broadcatching, photocasting, picturecasting, screencasting, Vloging, and MP3 blogs.) In mid 2000, use of RSS spread to many major news organizations, including Reuters, CNN, and the BBC, under various usage agreements, providers allow other websites to incorporate their ‘syndicated’ headline or headline-and-short-summary feeds. RSS is now used for many purposes, including marketing, bug-reports, or any other activity involving periodic updates or publications.”

### SUMMARY

Described herein are one or more implementations for exposing data content (e.g., digital media) of a portable digital media device over a network to one or more network-connected electronics devices, where such exposing is done via a network-connected personal computer to which the portable digital media device is directed coupled (e.g., via a USB). Also, described herein are one or more implementations for gathering a customized collection of data content from web-feeds at a web-connected personal computer and exposing that gathered web-feed data content to a network-connected electronics devices (such as a set-top box for a television).

This summary is provided to introduce a selection of concepts in a simplified form that are further described below in the Detailed Description. This Summary is not intended to identity key features or essential features of the claimed subject matter, nor is it intended to be used as an aid in determining the scope of the claimed subject matter.

### BRIEF DESCRIPTION OF THE DRAWINGS

The same numbers are used throughout the drawings to reference like elements and features.

FIG. 1 shows exemplary network architecture in accordance with one or more implementations disclosed herein.

FIG. 2 shows a flow diagram of a methodological implementation in accordance with one or more implementations disclosed herein.

FIG. 3 shows a flow diagram of a methodological implementation in accordance with one or more implementations disclosed herein.

FIG. 4 is an example of a computing operating environment capable of (wholly or partially) implementing at least one embodiment described herein.

### DETAILED DESCRIPTION

Described herein is a technology for exposing data content (e.g., digital media) of a portable digital media device over a network to one or more network-connected electronics devices. With this technology, the data content exposure is done via a network-connected personal computer to which the portable digital media device is directed coupled (e.g., via a USB). Also described herein is a technology for gathering a customized collection of data content from web-feeds (e.g., RSS feeds) at a web-connected personal computer and exposing that gathered web-feed data content to a network-connected electronics devices (such as a set-top box for a television).

As used herein, data content expressly includes digital audio, digital music, digital images, digital video, digital multimedia, and any other renderable digital content, which may be stored and distributed to and from computers and portable devices.

Exemplary Environment

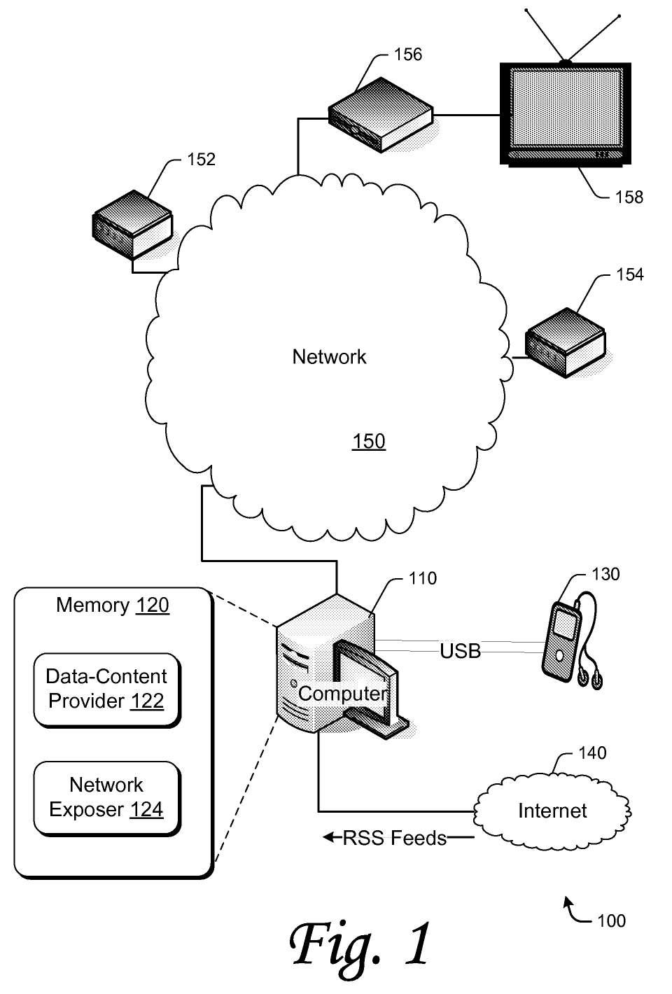

FIG. 1 shows an exemplary environment 100 within which one or more embodiments, described herein, may be implemented. As depicted, the exemplary environment 100 includes a computer (such as a personal computer) 110 with memory 120. The memory 120 may be any available processor-readable media that is accessible by computer 110. The memory 120 may be either volatile or non-volatile media. In addition, it may be either removable or non-removable media.

Running in that memory 120 are two software modules: a data-content provider 122 and a network exposer 124. These software modules may be application programming interfaces (APIs), device drivers, applications, programs, or the anything similar. Although called software modules herein, the data-content provider 122 and the network exposer 124 may be implemented in software alone, hardware alone, firmware alone, or some combination thereof. The broad concepts of data providing and exposing that data over a network are familiar territory in the realm of UPnP architecture and technology.

A removable, portable media device 130 is directly coupled to the computer 110 via a short-range direct physical interface coupling, such as universal serial bus (USB), IEEE 1394 (“firewire”), and the like. Such a removable, portable media device 130 may consist of, for example, a media player with a solid-state flash drive, a hard-drive mounted in a chassis, or other device non-volatile memory. Examples of the portable media device 130 include the so-called “mp3 player” and “digital video player.” Digital data content (such as music and video) is stored on the portable media device 130. In addition, portable storage devices may be exposed through short range wireless interface as well as wired. In this scenario, the PC will act as an “aggregator” of the content and it will be independent of physical means of connectivity.

As depicted, the computer 110 is connected to a public computer communications network, such as the Internet 140, and connected to a plug-n-play network 140. The plug-n-play network 140 may employ, for example, a Universal Plug and Play (UPnP) network architecture that facilitates adding and removing devices from a network.

In addition to the computer 110, FIG. 1 shows other network-connected electronics devices (152, 154, and 156) connected to the plug-n-play network 140. In this example, these electronics devices are UPnP device and may include a variety of electronic devices. Exemplary network-connected electronics devices include computers of all types, CD/DVD players/jukeboxes, TVs, VCRs, MP3 players, stereo systems, electronic picture frames (EPFs), various types of still and video cameras, Digital Media Receivers (DMRs), connected DVDs, digital audio receivers (DARs), digital media hubs, digital media players, digital media streamers, digital video receivers, network media players, networked DVDs, networked entertainment gateways, and so on.

As depicted, device 156 is a DMR, which is a consumer electronics device that receives digital media streams from a computer over a wired or wireless home network (such as the plug-n-play network 140). Some DMRs have integrated displays and speakers. Others, like DMR 156, are connected to an external output device, such as a television 158, powered speakers, or a stereo system.

The plug-n-play network 140 can couple the devices (152, 154, and 156) together using the Transmission Control Protocol and the Internet Protocol (TCP/IP). Of course, the plug-n-play network 140 can also freely draw from a number of other standard protocols, such as Hypertext Transfer Protocol (HTTP), Simple Object Access Protocol (SOAP), General Event Notification Architecture (GENA), and so on. The plug-n-play network 140 can be physically implemented using a variety of hardwired and/or wireless communication mechanisms, such as phone lines, power lines, Infrared Data Association (IrDa), Ethernet, Radio Frequency (RF) coupling, WiFi, and so on.

A suitable operating and networking environment for the implementations described herein are shown in FIGS. 3-7 of co-pending U.S. patent application Ser. No. 10/742,588 (which is incorporated herein by reference) and described in the textual descriptions associated with those drawings figures.

Exposure of Data Content from Computer-Coupled Devices

In one implementation, the computer 110 and the portable media device 130 are physically coupled in a manner that allows normal and typical communication there between. Indeed, this arrangement is often done to allow the computer 110 and portable media device 130 to synchronize (“synch”) the data content stored on the media device.

Digital media (such as music and video) is often protected via a form of Digital Rights Management (DRM) and it is common for a portable digital media player (such as the portable media device 130) to respect and help manage the DRM rights of digital media stored thereon. Therefore, a DRM-protected media file stored on an authorized portable media device will play on the device, but will not play if transferred to an unauthorized device or personal computer.

Furthermore, in conventional approaches, network-connected devices cannot access data content stored on a portable media device that is physically coupled to a computer, which is connected to the same network as the network-connected devices. With reference to FIG. 1, that statement may restated like this: in conventional approaches, network-connected devices—such as devices (152, 154, and 156) on the plug-n-play network 150—cannot access data content stored on a portable media device—such as the portable media device 130—that is physically coupled to a computer 110.

However, using implementations described herein, network-connected devices—such as devices (152, 154, and 156) on the plug-n-play network 150—can be aware of and access the data content stored on a portable media device—such as the portable media device 130—that is physically coupled to a computer 110. In this context, the data content on the portable media devices may be viewed as “external-network” data content because the data content is external to the network common to the computer and devices, which is, in this case, the plug-n-play network 150. The data on the portable device 130 is available to the computer because the portable device is directly coupled to the computer, but data content is unavailable (and thus “external”) to the devices on the plug-n-play network 150.

More specifically, the data-content provider 122 is specifically configured to interface with the portable media device 130 and acquire information related to the data content stored thereon. Typically, the data-content provider 122 is specifically programmed to interface with one or more specific types, brands, and/or standards of portable media devices.

Once discovered, the network exposer 124 exposes (i.e., makes available for browsing, use, copying, and/or other data specific functions) the data content of the portable media device 130 to the network-connected devices—such as devices (152, 154, and 156). Consequently, the network-connected devices may access and consume the data content stored on the portable media device 130.

For example, the portable media device 130 may store a video of an episode of a popular TV-series. With the implementations described herein, the DMR 156 may discover that TV episode stored on the computer-coupled media device and play the video on its attached television 158. Even when the TV episode is DRM-protected, the DMR 156 may still access the data content because the portable media device 130 is authorized to play the TV episode.

Exposure of Customized Web-Feed Collections

In another implementation, the computer 110 is connected to a public computer communications network, such as the Internet 140. Via this Internet connection, the computer may acquire “web-feeds,” which are commonly called “RSS feeds.” The typical data content of web-feeds includes, for example, news feeds, events listings, weather updates, news stories, headlines, project updates, and excerpts from discussion forums.

In this context, the data content derived from web-feeds is viewed as “external-network” data content because the web-feed data content is external to the network common to the computer and devices, which is, in this case, the plug-n-play network 150. The web-feed data content is available to the computer because the computer is directly coupled to the Internet, but the web-feed data content is unavailable (and thus “external”) to the devices on the plug-n-play network 150.

Using a user-interface, a user selects web-feeds that interests the user. Alternatively, web-feeds may be automatically selected based upon defaults and/or user preferences. Regardless, the web-feeds are customized and collected together continuously or on a fixed schedule. More specifically, the data-content provider 122 is specifically configured to access, acquire, and gather the customized collection of web-feeds from the Internet 140.

Once accessed, acquired, and gathered, the network exposer 124 exposes (i.e., makes available for browsing, use, copying, and/or other data specific functions) the customized web-feed data content collection to the network-connected devices—such as devices (152, 154, and 156). Consequently, the network-connected devices may access and consume the customized web-feed data content collection.

For example, the DMR 156 may discover the current edition of the customized web-feed data content collection from the network exposer 122. The DMR 156 may render the text and display the text full-screen on its attached television 158. Alternatively, the DMR 156 may render the text as a horizontal scrolling text and display the customized web-feed data content collection in the form of a “newscrawler.” Also, instead of the DMR rendering the text for display on its TV, the network exposer 122 may render the text before sending it to the DMR.

Methodological Implementations

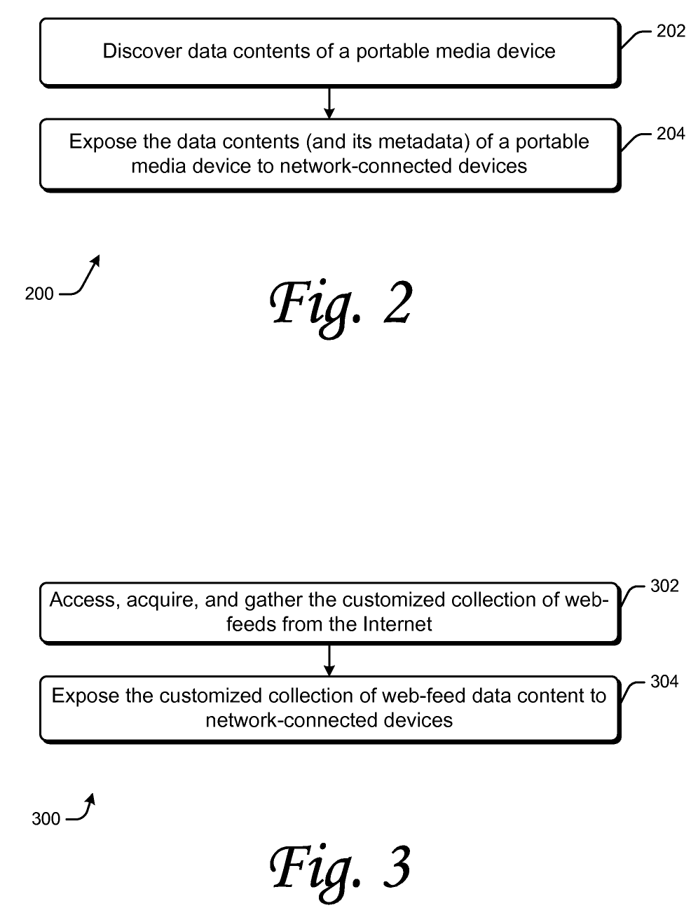

FIG. 2 shows a method 200 for exposing data content of a computer-connected portable media device to network-connected devices. This method 200 is performed by the one or more of the various components as depicted in FIG. 1. Furthermore, this method 200 may be performed in software, hardware, or a combination thereof. For ease of understanding, this method is delineated as separate steps represented as independent blocks in FIG. 2; however, these separately delineated steps should not be construed as necessarily order dependent in their performance. Additionally, for discussion purposes, the method 200 is described with reference to FIG. 1. Also for discussion purposes, particular components are indicated as performing particular functions; however, other components (or combinations of components) may perform the particular functions.

At 202 of FIG. 2, the data-content provider 122 discovers data contents of a portable media device (such as device 130) which is directly coupled to a computer. Part of the discovery includes information (e.g., metadata) associated with the data content.

At 204, the network exposer 124 exposes the data contents (and its metadata) of a portable media device (such as device 130) to network-connected devices (such as devices 152, 154, and 156 on the plug-and-play network 150.

FIG. 3 shows a method 300 for exposing customized collection of web-feed data content to network-connected devices. This method 300 is performed by the one or more of the various components as depicted in FIG. 1. Furthermore, this method 300 may be performed in software, hardware, or a combination thereof. For ease of understanding, this method is delineated as separate steps represented as independent blocks in FIG. 3; however, these separately delineated steps should not be construed as necessarily order dependent in their performance. Additionally, for discussion purposes, the method 300 is described with reference to FIG. 1. Also for discussion purposes, particular components are indicated as performing particular functions; however, other components (or combinations of components) may perform the particular functions.

At 302 of FIG. 3, the data-content provider 122 accesses, acquires, and gathers the customized collection of web-feeds from the Internet 140.

At 304, the network exposer 124 exposes the customized collection of web-feeds data content to network-connected devices (such as devices 152, 154, and 156 on the plug-and-play network 150.

Exemplary Computing System and Environment

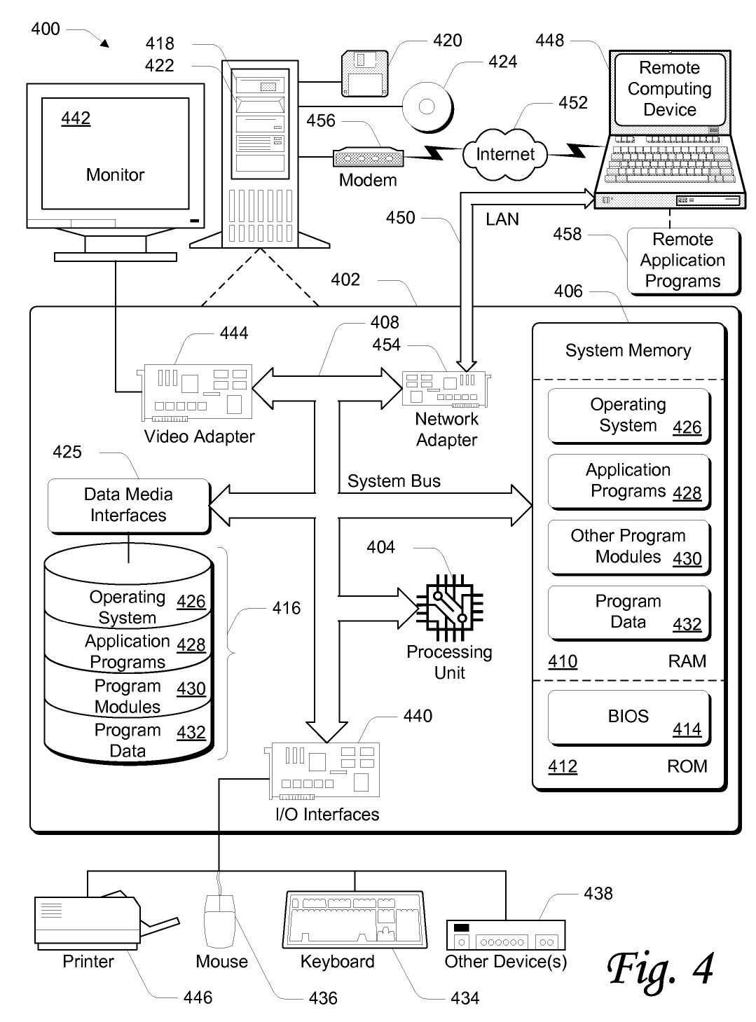

FIG. 4 illustrates an example of a suitable computing environment 400 within which an exemplary network-external data content exposer, as described herein, may be implemented (either fully or partially). The computing environment 400 may be utilized in the computer and network architectures described herein.

The exemplary computing environment 400 is only one example of a computing environment and is not intended to suggest any limitation as to the scope of use or functionality of the computer and network architectures. Neither should the computing environment 400 be interpreted as having any dependency or requirement relating to any one or combination of components illustrated in the exemplary computing environment 400.

The exemplary network-external data content exposer may be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, personal digital assistants (PDA), appliances, special-purpose electronics (e.g., a DVD player), programmable consumer electronics, network PCs, minicomputers, mainframe computers, distributed computing environments that include any of the above systems or devices, and the like.

The exemplary network-external data content exposer may be described in the general context of computer-executable instructions, such as program modules, being executed by a computer. Generally, program modules include routines, programs, objects, components, data structures, etc. that perform particular tasks or implement particular abstract data types. The exemplary network-external data content exposer may also be practiced in distributed computing environments where tasks are performed by remote processing devices that are linked through a data-communications network. In a distributed computing environment, program modules may be located in both local and remote computer storage media including memory storage devices.

The computing environment 400 includes a general-purpose computing device in the form of a computer 402. The components of computer 402 may include, but are not limited to, one or more processors or processing units 404, a system memory 406, and a system bus 408 that couples various system components, including the processor 404, to the system memory 406.

The system bus 408 represents one or more of any of several types of bus structures, including a memory bus or memory controller, a peripheral bus, an accelerated graphics port, and a processor or local bus using any of a variety of bus architectures. By way of example, such architectures can include a CardBus, Personal Computer Memory Card International Association (PCMCIA), Accelerated Graphics Port (AGP), Small Computer System Interface (SCSI), Universal Serial Bus (USB), IEEE 1394, a Video Electronics Standards Association (VESA) local bus, and a Peripheral Component Interconnects (PCI) bus, also known as a Mezzanine bus.

Computer 402 typically includes a variety of computer-readable media. Such media may be any available media that is accessible by computer 402 and includes both volatile and non-volatile media, removable and non-removable media.

The system memory 406 includes computer-readable media in the form of volatile memory, such as random access memory (RAM) 410, and/or non-volatile memory, such as read only memory (ROM) 412. A basic input/output system (BIOS) 414, containing the basic routines that help to transfer information between elements within computer 402, such as during start-up, is stored in ROM 412. RAM 410 typically contains data and/or program modules that are immediately accessible to and/or presently operated on by the processing unit 404.

Computer 402 may also include other removable/non-removable, volatile/non-volatile computer storage media. By way of example, FIG. 4 illustrates a hard disk drive 416 for reading from and writing to a non-removable, non-volatile magnetic media (not shown), a magnetic disk drive 418 for reading from and writing to a removable, non-volatile magnetic disk 420 (e.g., a “floppy disk”), and an optical disk drive 422 for reading from and/or writing to a removable, non-volatile optical disk 424 such as a CD-ROM, DVD-ROM, or other optical media. The hard disk drive 416, magnetic disk drive 418, and optical disk drive 422 are each connected to the system bus 408 by one or more data media interfaces 425. Alternatively, the hard disk drive 416, magnetic disk drive 418, and optical disk drive 422 may be connected to the system bus 408 by one or more interfaces (not shown).

The disk drives and their associated computer-readable media provide non-volatile storage of computer readable instructions, data structures, program modules, and other data for computer 402. Although the example illustrates a hard disk 416, a removable magnetic disk 420, and a removable optical disk 424, it is to be appreciated that other types of computer-readable media, which may store data that is accessible by a computer, such as magnetic cassettes or other magnetic storage devices, flash memory cards, CD-ROM, digital versatile disks (DVD) or other optical storage, random access memories (RAM), read only memories (ROM), electronically erasable programmable read-only memory (EEPROM), and the like, may also be utilized to implement the exemplary computing system and environment.

Any number of program modules may be stored on the hard disk 416, magnetic disk 420, optical disk 424, ROM 412, and/or RAM 410, including, by way of example, an operating system 426, one or more application programs 428, other program modules 430, and program data 432.

A user may enter commands and information into computer 402 via input devices such as a keyboard 434 and a pointing device 436 (e.g., a “mouse”). Other input devices 438 (not shown specifically) may include a microphone, joystick, game pad, satellite dish, serial port, scanner, and/or the like. These and other input devices are connected to the processing unit 404 via input/output interfaces 440 that are coupled to the system bus 408, but may be connected by other interface and bus structures, such as a parallel port, game port, or a universal serial bus (USB).

A monitor 442 or other type of display device may also be connected to the system bus 408 via an interface, such as a video adapter 444. In addition to the monitor 442, other output peripheral devices may include components, such as speakers (not shown) and a printer 446, which may be connected to computer 402 via the input/output interfaces 440.

Computer 402 may operate in a networked environment using logical connections to one or more remote computers, such as a remote computing device 448. By way of example, the remote computing device 448 may be a personal computer, a portable computer, a server, a router, a network computers a peer device or other common network node, and the like. The remote computing device 448 is illustrated as a portable computer that may include many or all of the elements and features described herein, relative to computer 402.

Logical connections between computer 402 and the remote computer 448 are depicted as a local area network (LAN) 450 and a general wide area network (WAN) 452. Such networking environments are commonplace in offices, enterprise-wide computer networks, intranets, and the Internet. Such networking environments may be wired or wireless.

When implemented in a LAN networking environment, the computer 402 is connected to a local network 450 via a network interface or adapter 454. When implemented in a WAN networking environment, the computer 402 typically includes a modem 456 or other means for establishing communications over the wide network 452. The modem 456, which may be internal or external to computer 402, may be connected to the system bus 408 via the input/output interfaces 440 or other appropriate mechanisms. It is to be appreciated that the illustrated network connections are exemplary and that other means of establishing communication link(s) between the computers 402 and 448 may be employed.

In a networked environment, such as that illustrated with computing environment 400, program modules depicted, relative to the computer 402 or portions thereof, may be stored in a remote memory storage device. By way of example, remote application programs 458 reside on a memory device of remote computer 448. For purposes of illustration, application programs and other executable program components, such as the operating system, are illustrated herein as discrete blocks, although it is recognized that such programs and components reside at various times in different storage components of the computing device 402, and are executed by the data processor(s) of the computer.

Computer-Executable Instructions

An implementation of an exemplary network-external data content exposer may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Exemplary Operating Environment

FIG. 4 illustrates an example of a suitable operating environment 400 in which an exemplary network-external data content exposer may be implemented. Specifically, the exemplary network-external data content exposer(s) described herein may be implemented (wholly or in part) by any program modules 428-430 and/or operating system 426 in FIG. 4, or a portion thereof

The operating environment is only an example of a suitable operating environment and is not intended to suggest any limitation as to the scope or use of functionality of the exemplary network-external data content exposer(s) described herein. Other well known computing systems, environments, and/or configurations that are suitable for use include, but are not limited to, personal computers (PCs), server computers, hand-held or laptop devices, multiprocessor systems, microprocessor-based systems, programmable consumer electronics, wireless phones and equipment, general and special-purpose appliances, application-specific integrated circuits (ASICs), network PCs, minicomputers, mainframe computers, distributed computing environments that include any of the above systems or devices, and the like.

Computer-Readable Media

An implementation of an exemplary network-external data content exposer may be stored on or transmitted across some form of computer-readable media. Computer-readable media may be any available media that may be accessed by a computer. By way of example, computer-readable media may comprise, but is not limited to, “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

“Communication media” typically embodies computer-readable instructions, data structures, program modules, or other data in a modulated data signal, such as carrier wave or other transport mechanism. Communication media also includes any information delivery media.

Conclusion

The discussion herein focuses on the Universal Plug and Play (UPnP) architecture and network. However, that specific network framework is merely exemplary. The functionality of the described implementations may and can be implemented using other kinds of architectures and networks (that is, the functionality is not limited to networks that include UPnP entities).

Generally, the terms “entity” and “device” should be construed broadly herein. These terms can refer to discrete standalone units for performing ascribing tasks, can comprise systems composed of multiple units, or can comprise hardware and/or software components contained within units, and so on.

The techniques, described herein, may be implemented in many ways, including (but not limited to) program modules, general- and special-purpose computing systems, network servers and equipment, dedicated electronics and hardware, and as part of one or more computer networks. The techniques may, for example, be implemented on a computer system depicted in FIG. 4.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A system comprising:
a data-content provider configured to discover network-external data content, which is data content which is normally unavailable to most electronic devices connected to a common network;
a network-exposer configured to expose the discovered network-external data content to multiple electronic devices on the common network.

2. A system as recited in claim 1, wherein the network-external data content is stored on a portable storage device configured to be coupled to a computer, which is connected to the common network.

3. A system as recited in claim 1, wherein the network-external data content is stored on a portable digital media player configured to be coupled to a computer.

4. A system as recited in claim 1, wherein the network-external data content is stored on a portable digital media player configured to be coupled to a computer and wherein the data content is selected from a group consisting of digital audio, digital music, digital images, digital video, digital multimedia, and any other renderable digital content, which may be stored and distributed to and from computers and portable devices.

5. A system as recited in claim 1, wherein the network-external data content is derived from multiple web-feeds.

6. A system as recited in claim 1, wherein the network-external data content is derived from multiple web-feeds and is selected from a group consisting of digital audio, digital music, digital images, and digital video.

7. A system comprising:
a data-content provider configured to discover data content stored on a portable storage device that is directly coupled to a computer, the computer being connected to a common network;
a network-exposer configured to expose the discovered data content to one or more network-connected electronic devices over the common network.

8. A system as recited in claim 7, wherein the portable storage device is a portable digital media player.

9. A system as recited in claim 7, wherein the portable storage device is configured to be coupled to the computer via direct connection.

10. A system as recited in claim 7, wherein the data content is selected from a group consisting of digital audio, digital music, digital images, digital video, digital multimedia, and any other renderable digital content, which may be stored and distributed to and from computers and portable devices.

11. A system comprising:
a data-content provider configured to acquire web-feed data content from a web-feed communication network;
a network-exposer configured to expose the acquired web-feed data content to one or more network-connected electronic devices over a network, which is not the web-feed communications network.

12. A system as recited in claim 11, wherein data-content provider is further configured to collect multiple web-feeds for the acquired data content.

13. A system as recited in claim 11, wherein data-content provider is further configured to customize the collection of multiple web-feeds of the acquired data content.

14. A system as recited in claim 11, wherein acquired web-feed data content is derived from RSS formatted feeds.

15. A system as recited in claim 11, wherein the acquired web-feed data content is selected from a group consisting of digital audio, digital music, digital images, digital video, digital multimedia, and any other renderable digital content, which may be stored and distributed to and from computers and portable devices.

16. A method comprising the acts of:
discovering data content stored on a portable storage device that is directly coupled to a computer, the computer being connected to a common network;
exposing the discovered data content to one or more network-connected electronic devices over the common network.

17. A method as recited in claim 16, further comprising providing the discovered data content to one or more network-connected electronic devices over the common network.

18. A method as recited in claim 16, wherein the portable storage device is a portable digital media player.

19. A method comprising the acts of:
acquiring web-feed data content from a web-feed communication network;
exposing the acquired web-feed data content to one or more network-connected electronic devices over a network, which is not the web-feed communications network.

20. A method as recited in claim 19 further comprising collecting a customized collection of the acquired web-feed data content.

21. A method as recited in claim 19 further comprising rendering the acquired web-feed data content for display on a video screen as a “newscrawler” over video being presented on the video screen.

22. A method as recited in claim 19, wherein the web-feed data content comprises one or more RSS-feeds.

23. A method as recited in claim 19, wherein the web-feed data content comprises textual characters, the method further comprising presenting the web-feed data content in a computer-readable textual format to the one or more network-connected electronic devices.

24. A method as recited in claim 19 the method further comprising:
converting textual characters of the web-feed data content into a computer-readable digital image format;
presenting the web-feed data content in a computer-readable digital image format to the one or more network-connected electronic devices.

25. A method as recited in claim 19 the method further comprising:
text-to-speech converting textual characters of the web-feed data content into a computer-readable digital audio format;
presenting the web-feed data content in a computer-readable digital audio format to the one or more network-connected electronic devices.
